(19) United States
(12) Patent Application Publication
(10) Pub. No.: US 2022/0274089 A1
(43) Pub. Date: Sep. 1, 2022

(54) Processes For Reducing Environmental Availability of Environmental Pollutants

(71) Applicant: Albemarle Corporation, Charlotte, NC (US)

(72) Inventors: Qunhui Zhou, Concord, CA (US); Se H. Kim, Baton Rouge, LA (US); Jon E. Miller, Baton Rouge, LA (US); Sascha J. Welz, Phoenix, AZ (US)

(21) Appl. No.: 17/637,623

(22) PCT Filed: Sep. 16, 2020
(86) PCT No.: PCT/US2020/051013

§ 371 Date: Feb. 23, 2022

Related U.S. Application Data
(60) Provisional application No. 62/900,876, filed on Sep. 16, 2019.

(51) Int. Cl. B01J 20/20; B01J 20/32; C02F 1/28; B09C 1/08

(52) U.S. Cl. CPC B01J 20/20; B01J 20/3204; B01J 20/3289; B01J 20/3287; C02F 1/283; C02F 1/288; B09C 1/08; B09C 1/002

(57) ABSTRACT

This invention provides processes for reducing the environmental availability of one or more environmental pollutants in solids, liquids, and combinations of solids and liquids.

### TECHNICAL FIELD

This invention relates to remediation of environmental pollutants to reduce their environmental availability.

### BACKGROUND

Many pollutants are known be toxic to humans and to the environment. One of these known environmental pollutants, mercury, has been categorized as a priority hazardous substance by the Agency for Toxic Substances and Disease Registry (ATSDR) of the U.S. Health and Human Services Department. The U.S. National Priorities List (NPL), maintained by the U.S. Environmental Protection Agency (EPA), has listed numerous sites that were contaminated by mercury, such sites comprising various pollutant-containing substances, including solids (e.g., soil, debris, waste), liquids (e.g., groundwater, lakes, ponds), and combinations of solids and liquids (e.g., sludge, slurries, sediments). The majority of these sites have not been de-contaminated to remove mercury. Unacceptable levels of mercury or mercury compounds may also be present in sites not listed in the U.S. NPL. Environmental pollutants other than mercury raise similar concerns.

Mercury contamination can come from a variety of different sources such as mining and ore processes, chlor-alkali plants, and battery manufacturing processes. There also are many landfills contaminated with mercury-containing waste. Additionally, mercury pollutants are present in multiple forms including metallic mercury, organic mercury compounds, and inorganic mercury compounds, often at the same site. Different mercury forms and/or different substances often require different treating methods.

Mercury contaminated substances are likely to also comprise multiple other environmental pollutants. For example, some substances are also contaminated with organics and/or other heavy metals, and these other environmental pollutants provide similar challenges. Therefore, reducing the environmental availability of environmental pollutants at any particular site can be technically challenging and costly, depending on the substance that is contaminated, condition of the substance, waste types, mercury forms, and other contaminants or environmental pollutants present. Reducing the environmental availability of environmental pollutants, which in turn reduces the bio-availability of pollutants and thus their bio-accumulation, especially in substances such as soils, groundwaters, sediments, and slurries, is of particular interest.

Current commercial remediation processes applied to soils and other solids include stabilization/solidification, washing, thermal desorption, and vitrification. Processes applied to water and other liquids include precipitation/co-precipitation, adsorption, filtration, and bioremediation. Processes applied to sediments and other combinations of solids and liquids include in situ capping, dredging/excavation, a combination of these approaches, as well as Monitored Natural Recovery (MNR) and enhanced Monitored Natural Recovery (EMNR). Monitored natural recovery relies on natural processes to protect the environment and receptors from unacceptable exposures to contaminants, while enhanced MNR applies material or amendments to enhance natural recovery processes (such as the addition of a thin-layer cap or a reactive amendment such as carbon). These remediation technologies all provide benefits in controlling environmental impacts from environmental pollutants, including human health and ecological risks, but these remediation technologies also have limitations.

Another factor to be considered for some remediation technologies is the tendency for an environmental pollutant to migrate from (or leach out of) its location after it has been sequestered or stabilized. The U.S. EPA regulates this as well, and has a Toxicity Characteristic Leaching Procedure (TCLP), a test designed to determine the mobility of both organic and inorganic analytes present in liquid, solid, and multiphasic wastes.

Complicated bench- and pilot-scale research and screening tests have to be conducted to evaluate a technology to determine if it is suitable before it is selected to remediate an actual contaminated site. In addition, the variability with each site to be treated makes the remediation of mercury and other environmental pollutants contamination quite expensive and time-consuming. Thus, there is a need for new and more commercially attractive processes for reducing environmental availability and bio-availability of environmental pollutants in solids and liquids, as well as in combinations thereof.

### SUMMARY OF THE INVENTION

This invention provides processes for reducing environmental availability of at least a portion of one or more environmental pollutants in a substance comprising one or more environmental pollutants. A benefit provided by the processes of this invention is a reduction of environmental availability of toxic environmental pollutants in substances. Such toxic pollutants include mercury and methyl mercury, as well as heavy metals and ecologically toxic organic matter.

An advantage provided by the processes of this invention is that by reducing environmental availability of environmental pollutants in substances, bio-availability and bio-accumulation of such pollutants is also reduced.

Processes of this invention can be used as the sole process for reducing the environmental availability and/or the presence of environmental pollutants, such as mercury, in a substance, or can be used to complement and/or enhance the reduction in environmental availability and/or the amount of such environmental pollutants in the substance than is attained by existing technologies.

An embodiment of this invention is a process for reducing environmental availability of at least a portion of one or more environmental pollutants in a substance comprising one or more environmental pollutants. This process comprises adding and/or applying a sorbent containing halogen and sulfur to the substance. The sorbent comprises sulfur, one or more halogens selected from fluorine, chlorine, bromine, and/or iodine, and one or more substrate materials. The halogen in the sorbent is from a source selected from elemental halogens, hydrohalic acids, alkali metal halides, alkaline earth metal halides, and ammonium halides. Adding and/or applying the sorbent containing halogen and sulfur to the pollutant-containing substance reduces the environmental availability of at least a portion of one or more environmental pollutants in the substance.

Another embodiment of this invention is a sorbent containing halogen and sulfur.

These and other embodiments and features of this invention will be still further apparent from the ensuing description and appended claims.

### FURTHER DETAILED DESCRIPTION OF THE INVENTION

The present invention provides processes for reducing the environmental availability of environmental pollutants. As used throughout this document, the term “reducing environmental availability” refers to stabilizing, immobilizing, fixing, encapsulating, isolating, containing, destroying, detoxifying, decomposing, and decaying, reducing the amount of, reducing the mobility of, and/or reducing the migration ability of, at least one environmental pollutant. The stabilizing and/or immobilizing can be in a medium. Reducing the environmental availability of environmental pollutants in turn reduces the bio-availability of pollutants and thus their bio-accumulation.

As used herein, the terms “environmental pollutant” and “environmental pollutants” means a chemical element or compound or mixture thereof known be harmful humans and/or to impact the environment (ecosystem). Environmental pollutants are typically regulated by one or more government agencies. Examples of environmental pollutants include mercury in all of its forms, e.g., elemental mercury, organic mercury compounds, and inorganic mercury compounds; other organic matter (including, for example, without limitation, hydrophobic organic compounds, polycyclic aromatic hydrocarbons, polychlorinated biphenyls, dioxins, furans, and/or chlorinated pesticides); hazardous elements, organic and inorganic heavy metal compounds (including, for example, without limitation, compounds comprising As, Pb, Zn, Cu, Cr, and/or Cd); and other environmental pollutants known to those skilled in the art.

As used throughout this document, terms such as “treated”, “contacted”, and “remediated” indicate that the sorbent containing halogen and sulfur interacts with the substance containing one or more environmental pollutants in a manner that results in the reduction of environmental availability of one or more environmental pollutants.

The remediation agents in the practice of this invention are sorbents containing halogen and sulfur. Sorbents containing halogen and sulfur are typically formed from one or more sulfur compounds, one or more halogen-containing compounds, and one or more substrate materials. Many substrate materials, especially activated carbons, are available or obtainable in a wide range of particle sizes, from nanometer to centimeter.

Substrate materials include carbonaceous materials and inorganic materials; these substrate materials are non-oxidizing. Suitable carbonaceous materials include, for example, without limitation, activated carbon, carbon black, char, and coke. A preferred carbonaceous material is activated carbon, which can be used in many forms including, for example, without limitation, powdered, granular, or extruded; and high specific surface area. Powdered activated carbon is a particularly preferred form of activated carbon.

Suitable inorganic materials include inorganic oxides such as alumina (amorphous and crystalline), silica, magnesia and titania; natural zeolites, such as chabazite, clinoptilolite, and faujasite; synthetic zeolites, such as synthetic chabazite, zeolites with high Si:Al ratios (ZSM-5, beta zeolites, sodalite), zeolites with moderate Si:Al ratios (Y zeolites, A zeolites), silica alumina phosphate (SAPO) zeolites, ion exchanged zeolites, uncalcined zeolites, clay minerals such as kaolin, kaolinite, bentonite, and montmorillonite; synthetic clays such as laponite, saponite, sauconite, stevensite, kaolinite, and hectorite; organo-clays such as montmorillonite that has been treated with a trimethyl stearyl ammonium salt, a dimethyl dialkyl (C₁₄-C₁₈) ammonium salt, a methyl dihydroxyethyl ammonium salt and a hydrogenated tallow ammonium salt, and aminopropyltriethoxysilane and octadecylamine; bentonite, hectorite, hectorite, and attapulgite that have been treated with a quaternary ammonium salt; and zeolites that have been treated with N,N,N-trimethyl-1-hexadecanaminium chloride; inorganic hydroxides such as iron hydroxide; mixed metal oxides such as hydrotalcites and metallated double layered clays; diatomaceous earth; cement dust; hydroprocessing catalysts including those on substrates such as alumina, silica, or titania; CaCO₃; and combinations of any two or more of the foregoing. Preferred inorganic materials include inorganic oxides, especially silica, natural zeolites, especially chabazite, and clay minerals, especially kaolinite and bentonite; CaCO₃ is also a preferred substrate material.

The halogen element in the sorbent containing halogen and sulfur can be fluorine, chlorine, bromine, iodine, or a mixture of any two or more halogens. Bromine is a preferred halogen. The halogen in the sorbent is from a source selected from elemental halogens, hydrohalic acids, alkali metal halides, alkaline earth metal halides, and ammonium halides. Suitable halogen-containing compounds include, for example, without limitation, elemental iodine and/or iodine compounds, elemental bromine and/or bromine compounds, elemental chlorine and/or chlorine compounds, elemental fluorine and/or fluorine compounds, and other suitable halogen compounds, as will be known to those skilled in the art. Types of halogen-containing compounds that can be used include hydrohalic acids, alkali metal halides, alkaline earth halides, and ammonium halides.

Hydrohalic acids include hydrogen fluoride, hydrogen chloride, hydrogen bromide, and hydrogen iodide. Alkali metal halides include sodium fluoride, sodium chloride, sodium bromide, sodium iodide, potassium fluoride, potassium chloride, potassium bromide, and potassium iodide. Alkaline earth halides include magnesium fluoride, magnesium chloride, magnesium bromide, magnesium iodide, calcium fluoride, calcium chloride, calcium bromide, and calcium iodide. Ammonium halides include ammonium fluoride, ammonium chloride, ammonium bromide, and ammonium iodide.

Preferred halogen-containing compounds depend on which halogen is being combined with the substrate, and include elemental bromine, hydrogen bromide, sodium chloride, sodium bromide, potassium iodide, and calcium bromide. Bromine-containing compounds are preferred halogen-containing compounds; more preferred are hydrogen bromide and elemental bromine, especially elemental bromine.

The term “sulfur source” as used throughout this document means elemental sulfur and/or one or more sulfur compounds. Suitable sulfur sources include elemental sulfur (α, β, γ, and amorphous forms), and sulfur compounds. Sulfur compounds that are suitable sulfur sources include carbon disulfide, thioamides such as thioacetamide, and polymeric organosulfur compounds such as polythiocarbonic acid.

Salts of sulfur-containing ions (sulfur salts) are sulfur compounds that are suitable sulfur sources in the practice of this invention. The counterions of the sulfur salts can be cations of alkali metals (e.g., lithium, sodium, potassium, cesium), alkaline earth metals (e.g., magnesium, calcium, barium), ammonium, and zinc. Sulfur-containing ions that are suitable include thiosulfate, pyrosulfite, pyrosulfate, sulfite, hydrogen sulfite, sulfate, hydrogen sulfate, sulfide, hydrosulfide, dithiocarbomate, sym-triazinetrithiolate, and the like.

The sulfur sources can be anhydrous or hydrated; anhydrous sulfur sources are not necessary in the practice of this invention. Preferred sulfur sources include elemental sulfur and salts of sulfur-containing ions. Preferred sulfur-containing ions are sulfide, hydrosulfide, and polysulfides; preferred counterions are alkali metal cations. More preferred sulfur sources are elemental sulfur, sodium sulfide, and sodium hydrosulfide, especially elemental sulfur. Sulfur halides such as sulfur dibromide and sulfur chlorides are not employed as sulfur sources in the practice of this invention.

The sulfur sources usually can be used in solid form, in solution, or in gaseous form; carbon disulfide is conveniently used in liquid form, or in gaseous form due to its relatively low boiling point. Solutions are generally aqueous solutions. Concentrations of sulfur-containing solutions are typically about 0.2 wt % or more, usually in the range of about 0.2 wt to about 10 wt %, and preferably in the range of about 0.5 wt % to about 5 wt %. These concentrations refer to the amount of sulfur in solution, not the amount of the compound. Mixtures of two or more sulfur sources can be used; usually, such mixtures are in the same form (e.g., solid or solution). Preferred sulfur sources include elemental sulfur.

To achieve the desired amount of sulfur in the sorbent containing halogen and sulfur, an amount of the sulfur source that contains the appropriate amount of sulfur is combined with the halogen-containing compound and the substrate material. For example, to form a sorbent containing halogen and sulfur having 5 wt % sulfur, the weight of the sulfur source, the halogen-containing compound, and the substrate material are added together; when the amount of sulfur in the sulfur source is 5% of the total weight, a sorbent containing halogen and sulfur having about 5 wt % sulfur is formed, since all of the sulfur from the sulfur source is usually incorporated into the sorbent containing halogen and sulfur.

The amount of sulfur (or sulfur content) in the sorbent is typically in the range of about 0.1 wt % to about 10 wt %, preferably in the range of about 0.5 wt % to about 7.5 wt %, more preferably about 2 wt % to about 5 wt %, and still more preferably about 2.5 wt % to about 4 wt %, relative to the total weight of the sorbent containing halogen and sulfur.

In the sorbent containing halogen and sulfur, the sulfur and halogen are preferably in an atom ratio of sulfur to halogen in the range of about 0.25:1 to about 1:3, more preferably about 0.5:1 to about 1:2.5, and still more preferably about 1:1 to about 1:2.

Sorbents containing halogen and sulfur can be made from the substrate material, sulfur source, and halogen-containing compound as described in International Patent Pub. No. WO 2012/071206. The ingredients can be mixed together simultaneously or sequentially. When the mixing is sequential, the substrate material is typically combined with the sulfur source and then the halogen-containing compound.

Some of the sorbents containing halogen and sulfur that are compositions of the invention are formed by processes comprising contacting a halogen-containing compound and the substrate material to form a halogen-containing substrate material; the halogen-containing substrate material is contacted with a sulfur source to form the sorbent containing halogen and sulfur. In a variation of this process, an already-formed halogen-containing substrate material (e.g., a bromine-containing carbonaceous material) is contacted with a sulfur source to form the sorbent containing halogen and sulfur. Other sorbents containing halogen and sulfur that are compositions of the invention are formed by contacting a halogen-containing compound and a sulfur source to form a halogen-sulfur mixture; the halogen-sulfur mixture is contacted with a substrate material to form the sorbent containing halogen and sulfur. The substrate materials, halogen, halogen-containing compounds, sulfur sources, and amounts thereof and preferences therefor are as described above.

The contacting of the sulfur source and substrate material may be at ambient temperatures (e.g., about 20° C. to about 25° C.), or, preferably the contacting is performed with heating, preferably at one or more temperatures in the range of about 75° C. to about 700° C., more preferably about 100° C. to about 600° C., still more preferably about 100° C. to about 200° C. It is recommended and preferred to heat the sulfur source in contact with the substrate material whether or not the halogen-containing compound has already been combined with the substrate material.

When the halogen-containing compound and the sorbent material are contacted before contact with the sulfur-containing compound, the halogen-containing compound and the sorbent material can be contacted as described in U.S. Pat. Nos. 6,953,494 and 9,101,907. In some embodiments, preferred sorbents containing halogen and sulfur are sorbents containing bromine and sulfur. In some embodiments, preferred sorbents containing halogen and sulfur are sorbents in which the substrate material is an activated carbon. In other embodiments, preferred activated carbons containing halogen and sulfur are activated carbons containing chlorine and sulfur, activated carbons containing bromine and sulfur, and activated carbons containing iodine and sulfur. In preferred embodiments, the sorbents containing halogen and sulfur are activated carbons containing chlorine and sulfur and activated carbons containing bromine and sulfur. In more preferred embodiments, the sorbents containing halogen and sulfur are activated carbons containing bromine and sulfur.

In other embodiments, preferred sorbents containing halogen and sulfur are activated carbons containing chlorine and sulfur and activated carbons containing iodine and sulfur. In still other embodiments, preferred sorbents containing halogen and sulfur are chabazites containing halogen and sulfur, bentonites containing halogen and sulfur, kaolinites containing halogen and sulfur, and silicas containing halogen and sulfur.

In another embodiment, preferred sorbents containing halogen and sulfur include silica containing bromine and sulfur, kaolinite containing bromine and sulfur, and bentonite containing bromine and sulfur.

The amount of halogen (or halogen content) in the sorbent is typically equivalent to a total bromine content (or calculated as bromine) in the range of about 0.1 wt % to about 20 wt %, preferably equivalent to a total bromine content in the range of about 0.5 wt % to about 15 wt %, more preferably about 2 wt %/o to about 12 wt %, and still more preferably about 3 wt % to about 8 wt %, relative to the total weight of the sorbent containing halogen and sulfur.

As used throughout this document, the phrases “as bromine,” “reported as bromine,” “calculated as bromine,” and analogous phrases for the halogens refer to the amount of halogen, where the numerical value is calculated for bromine, unless otherwise noted. For example, elemental fluorine may be used, but the amount of halogen in the sorbent containing halogen and sulfur is stated as the value for bromine.

The amount of sulfur in the sorbent is typically in the range of about 0.1 wt % to about 15 wt %, preferably in the range of about 0.5 wt % to about 10 wt %, more preferably about 1 wt % to about 5 wt %/o, relative to the total weight of the sorbent containing halogen and sulfur.

Activated carbons containing bromine and sulfur suitable for use in processes of this invention can have a wide range of particle sizes and distributions, from nanometer to centimeter; and can be formed from activated carbon forms including, for example, without limitation, powdered, granular, or extruded; high specific surface area, a variety of unique pore structures; and other features as will be familiar to those skilled in the art.

Sorbents containing halogen and sulfur, especially sorbents containing bromine and sulfur, more especially activated carbons containing bromine and sulfur, can reduce environmental availability of pollutants in substances through means including, for example, without limitation, oxidation and/or adsorption. Adsorption can reduce the environmental availability of environmental pollutants by reducing mobility of such pollutants. Other ways in which sorbents containing halogen and sulfur can reduce environmental availability of pollutants are by enhancing the degradation of such pollutants through surface reactions; and/or by inhibiting the formation of pollutants such as methyl mercury; and/or by other mechanisms. In the processes of this invention, whether applied to solids, or liquids, or combinations thereof, the environmental pollutants adsorbed by sorbents containing halogen and sulfur are stabilized such that desorption into the environment is substantially minimized.

Mercury and other environmental pollutants can be removed by and/or become adsorbed onto or into sorbents containing halogen and sulfur, especially activated carbon containing bromine and sulfur, effectively removing the pollutants. Different halogen species can be formed on sorbents containing halogen and sulfur, especially sorbents containing bromine and sulfur, particularly activated carbon containing bromine and sulfur. For example, bromine, one of the bromine species, can oxidize elemental mercury and form mercuric bromide.

Some sorbents containing halogen and sulfur, particularly activated carbons containing bromine and sulfur, capture mercury, and may allow physical and/or chemical adsorption of mercury of different oxidation states including elemental mercury, oxidized mercury, and organic mercury. Mercury that has been captured by sorbents containing halogen and sulfur is stable in a wide range of pH values, where “stable” means that the mercury is not released from the sorbents containing halogen and sulfur in appreciable amounts after capture.

Sorbents containing halogen and sulfur used in processes of this invention can be combined with other optional components such as pH buffers (including, for example, without limitation, carbonates and phosphates); carriers (including, for example, without limitation, sand and mud); binders (including, for example, without limitation, mud, clay, and polymers); and/or other additives (including, for example, without limitation, iron compounds and sulfur compounds).

In the practice of this invention, the sorbent containing halogen and sulfur can be used in various forms, including as a dry sorbent or in combination with a suitable fluid, for example, in a slurry. As used herein, the term “suitable fluid” means fluids such as water, and other fluids. Those skilled in the art, given the teachings of this disclosure, have at hand the knowledge to select a suitable fluid, as the selection depends upon variables such as the composition of the substance, the composition of the environmental pollutants present in the substance, and the like.

Some treatments of substances can be conducted both in-situ and ex-situ.

Thermal desorption and retorting are two common ex situ methods of thermal treatment for mercury remediation. The technology heats a contaminated medium to volatilize mercury, followed by condensing vapors into liquid elemental mercury. Activated carbon containing bromine and sulfur may be used to adsorb mercury as a replacement of the liquid mercury condenser or to remove mercury in off-gasses exiting the condenser.

In some applications, the sorbent containing halogen and sulfur will remain in or with the substance. In other applications, the sorbent containing halogen and sulfur may be collected after use. When the sorbent containing halogen and sulfur is collected after use, the sorbent can be disposed of, or regenerated and re-used.

The substances containing one or more environmental pollutants are solids, liquids, or combinations of a solid and a liquid, or combinations of one or more solids and one or more liquids. When the substance is a solid, it may comprise more than one solid. When the substance is a liquid, it may comprise more than one liquid.

In some processes of this invention, whether applied to a substance comprising one or more solids, one or more liquids, or combinations of at least one solid and at least one liquid, use of the sorbent containing halogen and sulfur can be a stand-alone remedial approach or can complement the use of other remediation methods. In other processes according to the invention, the sorbent containing halogen and sulfur can be used in addition to one or more other remediation agents in the same remediation procedure.

Adding a sorbent containing halogen and sulfur into contaminated waste adsorbs one or more pollutants. In some embodiments, the sorbent containing halogen and sulfur remains in the substance to stabilize and/or solidify the substance. In other embodiments, the combined sorbent containing halogen and sulfur and substance are placed in landfill, often with a binder and other compounds.

As used herein, the term “solid” and/or “solids”, include without limitation, soil, debris, waste and other such substances known to those skilled in the art. Soil is a preferred solid to treat in the practice of this invention. Processes of the invention are provided for reducing environmental availability of at least a portion of one or more environmental pollutants in a solid comprising one or more environmental pollutants. Substances which are solids are sometimes referred to herein as solid substances.

The adding and/or applying of the sorbent containing halogen and sulfur to the solid can comprise:
(a) injecting a sorbent containing halogen and sulfur into the solid, optionally through holes and/or wells and/or channels that are present in the substance, whether already present or manually created, e.g., by drilling into the substance; and/or
(b) applying the sorbent containing halogen and sulfur to a surface of the solid; and/or
(c) combining the sorbent containing halogen and sulfur with at least a portion of a surface of the solid; and/or
(d) placing the sorbent containing halogen and sulfur in a vacuum well in which the solid is treated; and/or
(e) adding the sorbent containing halogen and sulfur to a contained solid; and/or
(f) combining the sorbent containing halogen and sulfur with the solid; and/or
(g) adding the sorbent containing halogen and sulfur to a reactive barrier; and/or
(h) forming a reactive barrier containing the sorbent containing halogen and sulfur.

Combining the sorbent containing halogen and sulfur with the surface of the solid as in (c) above can be done by combining the sorbent containing halogen and sulfur with a portion of the solid, and then applying the combination of sorbent containing halogen and sulfur and solid to the surface of the solid, or by combining the sorbent containing halogen and sulfur with the surface of the solid.

Some preferred methods for adding and/or applying the sorbent containing halogen and sulfur to the solid are:
(a) injecting a sorbent containing halogen and sulfur into the solid;
(b) applying a sorbent containing halogen and sulfur to a surface of the solid; and/or
(c) combining a sorbent containing halogen and sulfur with at least a portion of a surface of the solid.

An embodiment of treatment of solids to reduce environmental availability of one or more environmental pollutants involves (i) drilling holes, wells, and/or channels into the solid, (ii) covering a surface of the solid with a layer of sorbent containing halogen and sulfur, and (iii) heating some parts of the solid to migrate one or more environmental pollutants, e.g., mercury, toward the surface which has sorbent containing halogen and sulfur thereon.

Another embodiment of treatment of solids to reduce environmental availability of one or more environmental pollutants involves (i) drilling holes, wells, and/or channels into the solid, (ii) filling some holes or channels with sorbent containing halogen and sulfur, and (iii) purging heated air into holes or channels to migrate one or more environmental pollutants, e.g., mercury, toward the holes filled with sorbent containing halogen and sulfur.

In some embodiments of the invention, the solid is heated to vaporize the environmental pollutant, e.g., mercury, in a vacuum well, when a sorbent containing halogen and sulfur is present in the vacuum well as in (d) above, the sorbent containing halogen and sulfur can absorb the vaporized environmental pollutant(s). In these procedures, the sorbent containing halogen and sulfur is placed in the vacuum well in contact with the vapor produced in the vacuum well at one or more locations before the vapor exits to atmosphere. One application of this procedure is for Soil Vapor Extraction (SVE) for mercury remediation, and sorbents containing halogen and sulfur, especially activated carbons containing bromine and sulfur, can be placed in the vacuum well to adsorb mercury.

In a particular type of solid substance, soil, sorbents containing halogen and sulfur can be utilized to immobilize mercury prior to, or during stabilization and solidification (S/S) of soil in situ and/or ex situ treatment. One ex situ process adds sorbent containing halogen and sulfur, one or more binders, and other components into a contaminated substance and mixes them together in a reactor. The mixture is then stabilized and cemented or placed in landfill. In some embodiments, powdered activated carbon containing bromine and sulfur can be used in S/S treatment processes. Mercury adsorbed by powdered activated carbon containing bromine and sulfur is stable during making and curing of concrete. This is advantageous because fly ash and cement are typical binders used in S/S technologies.

In another embodiment of this invention in which sorbents containing halogen and sulfur, especially powdered activated carbons containing bromine and sulfur, are remediation agents for mercury contaminated soil, the sorbent containing halogen and sulfur is spread on top of the contaminated soil. In this method the soil is not disturbed and the sorbent containing halogen and sulfur, especially an activated carbon containing bromine and sulfur, is present in the top layer of soil and blocks migration of mercury from the soil.

Sorbents containing halogen and sulfur, especially activated carbons containing bromine and sulfur, can be mixed with another agent to create a mixture that improves penetration of the sorbent containing halogen and sulfur into the solid, especially soil. The amount of sorbent containing halogen and sulfur added may be less than 10% of the top layer of soil, and the top layer of soil may be up to 10 cm thick. In some embodiments, a pH adjustment agent is also applied, either separately or in admixture with the sorbent containing halogen and sulfur, optionally along with an agent that improves penetration of the sorbent containing halogen and sulfur into the solid.

Processes of the invention are provided for reducing environmental availability of at least a portion of one or more environmental pollutants in a liquid comprising one or more environmental pollutants. As used herein, the term “liquid” and/or “liquids”, include without limitation, groundwater, wastewater, surface water, salt water, fresh water (e.g., lakes, ponds), and other such substances known to those skilled in the art. Substances which are liquids are sometimes referred to herein as liquid substances.

The adding and/or applying of the sorbent containing halogen and sulfur and the liquid can comprise:
(a) injecting the sorbent containing halogen and sulfur into the liquid; if desired, the used sorbent can be filtered; and/or
(b) applying the sorbent containing halogen and sulfur to the surface of the liquid; and/or
(c) combining the sorbent containing halogen and sulfur with the liquid; and/or
(d) passing the liquid over a fixed bed comprising the sorbent containing halogen and sulfur; and/or
(e) passing the liquid through a filter comprising the sorbent containing halogen and sulfur; and/or
(f) pumping the liquid through a fixed bed or column containing the sorbent containing halogen and sulfur; and/or
(g) adding the sorbent containing halogen and sulfur to a contained volume of liquid.

Combining the sorbent containing halogen and sulfur with the liquid as in (c) above can be done by combining the sorbent containing halogen and sulfur with the bulk liquid, or by combining the sorbent containing halogen and sulfur with a portion of the liquid to form a slurry, and then combining the slurry with the remaining liquid.

Some substances are combinations of at least one solid and at least one liquid, and include sludge, slurries, sediments, pore water (e.g., soil pore water or sediment pore water) and other combinations of solids and liquids. Sediment, soil pore water, and sediment pore water are preferred combination substances to treat in the practice of this invention. These combinations are sometimes referred to as multiphasic substances. Processes of the invention are provided for reducing environmental availability of at least a portion of one or more environmental pollutants in a combination comprising one or more environmental pollutants. Substances which are combinations are sometimes referred to herein as combination substances.

The adding and/or applying of the sorbent containing halogen and sulfur and the combination can comprise adding and/or applying the sorbent containing halogen and sulfur to the combination. In such processes, adding and/or applying the sorbent containing halogen and sulfur to the combination can comprise:
(a) injecting the sorbent containing halogen and sulfur into the combination, optionally through holes and/or wells and/or channels that are present in the substance, whether already present or manually created, e.g., by drilling into the combination; and/or
(b) applying the sorbent containing halogen and sulfur to a surface of the combination; and/or
(c) combining the sorbent containing halogen and sulfur with at least a portion of a surface of the combination as described above for solid and/or liquid substances; and/or
(d) combining the sorbent containing halogen and sulfur with the combination; and/or
(e) placing the sorbent containing halogen and sulfur in a vacuum well in which the combination is treated, in a manner similar to that described for solid substances; and/or
(f) adding the sorbent containing halogen and sulfur to a contained combination; and/or
(g) covering a surface of the substance with a layer comprising the sorbent containing halogen and sulfur; and/or
(h) placing the sorbent containing halogen and sulfur into a cap; and/or
(i) adding the sorbent containing halogen and sulfur to a reactive barrier; and/or
(j) forming a reactive barrier containing the sorbent containing halogen and sulfur; and/or
(k) placing the sorbent containing halogen and sulfur within a geotextile mat.

Combining the sorbent containing halogen and sulfur with the combination as in (d) above can be done by combining the sorbent containing halogen and sulfur with the combination, or by combining the sorbent containing halogen and sulfur with a portion of the combination to form a mixture, and then combining the mixture with the surface of the combination. In these embodiments, the sorbent containing halogen and sulfur can comprise, for example, without limitation, an activated carbon containing halogen and sulfur, preferably a carbon sorbent containing bromine and sulfur, more preferably an activated carbon sorbent containing bromine and sulfur.

Some preferred methods for adding and/or applying the sorbent containing halogen and sulfur to the combination are:
(a) injecting a sorbent containing halogen and sulfur into the combination;
(b) applying a sorbent containing halogen and sulfur to a surface of the combination;
(c) combining a sorbent containing halogen and sulfur with at least a portion of a surface of the combination; and/or
(d) combining a sorbent containing halogen and sulfur with the combination.

As will be clear to those skilled in the art, depending upon the substance treated, numerous variables regarding use of this invention must be considered. In all of the processes of this invention, whether applied to solids, liquids, or combinations thereof, given the teachings herein, those skilled in the art have at hand the knowledge to determine amounts of sorbent containing halogen and sulfur to use; whether to use optional components in combination with the sorbent containing halogen and sulfur, and, if so, the specific optional components and amounts thereof that will be beneficial; the number of applications of processes of this invention, and the period of time between such applications, that will be beneficial; whether to use processes of this invention in combination with known remediation methods, and, if so, how to do so to obtain beneficial results, etc.

The following examples are presented for purposes of illustration, and are not intended to impose limitations on the scope of this invention.

In the Examples, unless otherwise specified, the amount of mercury present in a sample was determined in an atomic absorption spectrometer with a mercury vapor analyzer via cold vapor atomic absorption (CVAA; Atomic Absorption Mercury Spectrometer with Zeeman background correction, Ohio Lumex Co., model no. RA 915+).

In all of the Examples, runs using plain (untreated) activated carbon are comparative. The powdered activated carbon used in the Examples was prepared from coconut shells.

### Example 1—Comparative

A powdered activated carbon was dried and stored in a dry box under nitrogen. A portion of the powdered activated carbon (average particle size 15 μm) was treated with gas phase Br₂ at elevated temperature in a procedure as described in U.S. Pat. No. 6,953,494 to form a bromine-containing powdered activated carbon with a bromine content of 8 wt %.

For each run, a sorbent (0.4 g/L) was placed in a reactor bottle. Solutions containing 50 ppm Hg prepared from as Hg(NO₃)₂, and having a pH of 2 were added to the reactor bottles containing sorbent. The samples were rotated for 24 hours at 30 rpm, and each of the resulting mixtures was passed through a syringe filter (0.45 μm pore membrane) to separate the sorbent from the liquid. The mercury concentration of the filtered liquid from each solution was then determined. Results are summarized in Table 1.

TABLE 1

| | | | Hg | Adsorption |
|---|---|---|---|---|
| | Sorbent | Initial | adsorbed, | capacity |
| | conc.*, | Hg conc., | mg/g | relative |
| Sorbent | g/L | g/L | sorbent | to PAC |
| PAC | 0.0202 | 0.0463 | 0.0255 | 1.0 |
| Br-PAC | 0.0202 | 0.0463 | 0.0742 | 2.9 |

*Defined as sorbent weight (g) per total volume of Hg-contaminated solution (L).

### Example 2—Comparative

Four mixtures of PAC and elemental sulfur (3.2 wt % sulfur) were each placed in a quartz boat within a quartz tube. Each mixture was heated at a different temperature under N₂ for several minutes, and then cooled under N₂ before use. In each run, a sulfur-containing PAC (S-PAC; 0.4 g/L) was placed in a reactor bottle and treated with a mercury-containing solution as described in Example 1. Results are summarized in Table 2.

TABLE 2

| | | | | Hg | Adsorption |
|---|---|---|---|---|---|
| | | Sorbent | Initial | adsorbed, | capacity |
| | S treatment | conc.*, | Hg conc., | mg/g | relative |
| Sorbent | T, ° C. | g/L | g/L | sorbent | to PAC |
| S-PAC | ambient | 0.0206 | 0.0463 | 0.0252 | 1.0 |
| S-PAC | 200 | 0.0201 | 0.0463 | 0.0560 | 2.2 |
| S-PAC | 400 | 0.0201 | 0.0463 | 0.0598 | 2.3 |
| S-PAC | 600 | 0.0202 | 0.0463 | 0.0415 | 1.6 |

*Defined as sorbent weight (g) per total volume of Hg-contaminated solution (L).

### Example 3

Mixtures of bromine-containing PAC (Br-PAC; 8 wt % Br) prepared as in Example 1 and elemental sulfur (3.2 wt % sulfur) were each placed in a quartz boat within a quartz tube. Each mixture was heated at a different temperature under N₂ for several minutes, and then cooled under N₂ before use. In each run, a sulfur-and-bromine-containing PAC (S—Br-PAC; 0.4 g/L) was placed in a reactor bottle and treated with a mercury-containing solution as described in Example 1. Results are summarized in Table 3.

Elemental sulfur (28.6 wt %), and liquid Br₂ (71.4 wt %) were mixed together to form a solution. This solution was mixed with PAC, and samples of the mixtures of PAC, elemental sulfur (3.2 wt %), and liquid Br₂ (8 wt %) were each placed in a quartz boat within a quartz tube. Each mixture was heated at a different temperature under N₂ for several minutes, and then cooled under N₂ before use. In each run, a sulfur-and-bromine-containing PAC (S—Br-PAC; 0.4 g/L) was placed in a reactor bottle and treated with a mercury-containing solution as described in Example 1. Results are summarized in Table 3.

TABLE 3

| | | | | | | Adsorption |
|---|---|---|---|---|---|---|
| | | Treatment | Sorbent | Initial Hg | Hg adsorbed, | capacity relative |
| Sorbent | Br form | T, ° C. | conc.*, g/L | conc., g/L | mg/g sorbent | to PAC |
| S—Br-PAC | Br-PAC | ambient | 0.0206 | 0.0463 | 0.0851 | 3.3 |
| S—Br-PAC | Br-PAC | 200 | 0.0201 | 0.0463 | 0.0968 | 3.8 |
| S—Br-PAC | Br-PAC | 400 | 0.0201 | 0.0463 | 0.0834 | 3.3 |
| S—Br-PAC | Br-PAC | 600 | 0.0203 | 0.0463 | 0.0546 | 2.1 |
| S—Br-PAC | liq. Br₂ | ambient | 0.0205 | 0.0463 | 0.0955 | 3.7 |
| S—Br-PAC | liq. Br₂ | 100 | 0.0201 | 0.0463 | 0.0981 | 3.8 |
| S—Br-PAC | liq. Br₂ | 200 | 0.0206 | 0.0463 | 0.0822 | 3.2 |

*Defined as sorbent weight (g) per total volume of Hg-contaminated solution (L).

### Example 4

Several sorbents were prepared. The S—Br-PAC sorbent was formed as described in Example 3. In each run, a sorbent (0.4 g/L) was placed in a reactor bottle and treated with a mercury-containing solution as described in Example 1. Runs A and B are comparative; Run C is inventive. Results are summarized in Table 4.

TABLE 4

| | | Sorbent components, wt % | | | Hg adsorbed, | Hg adsorbed, |
|---|---|---|---|---|---|---|
| Run | Sorbent | PAC | Br | S | mg/g sorbent | mg/g PAC |
| A | PAC | 100 | — | — | 31.52 | 31.52 |
| B | C-PAC* (Br) | 92 | 8 | — | 58.8 | 63.78 |
| C | S—Br-PAC | 88.8 | 8 | 3.2 | 71.90 | 80.97 |

*A commercially-available brominated PAC that has been treated to be compatible with concrete; see published International Patent Application No. WO 2008/064360.

Further embodiments of the invention include, without limitation:

A) A process for reducing environmental availability of at least a portion of one or more environmental pollutants in a substance comprising one or more environmental pollutants, which process comprises
adding and/or applying a sorbent containing halogen and sulfur to said substance, wherein the sorbent containing halogen and sulfur
is an activated carbon containing bromine and sulfur, an activated carbon containing chlorine and sulfur, an activated carbon containing iodine and sulfur, a chabazite containing bromine and sulfur, a bentonite containing bromine and sulfur, a kaolinite containing bromine and sulfur, or a silica containing bromine and sulfur,
thereby reducing environmental availability of at least a portion of one or more environmental pollutants in the substance.

B) A process as in A) wherein the sorbent containing halogen and sulfur has a halogen content of about 0.1 to about 20 wt % calculated as bromine relative to the total weight of the sorbent containing halogen and sulfur.

C) A process as in A) wherein the sorbent containing halogen and sulfur has a halogen content of about 0.5 wt % to about 15 wt % calculated as bromine relative to the total weight of the sorbent containing halogen and sulfur.

D) A process as in A) wherein the sorbent containing halogen and sulfur has a halogen content of about 2 wt % to about 12 wt % calculated as bromine relative to the total weight of the sorbent containing halogen and sulfur.

E) A process as in A) wherein the sorbent containing halogen and sulfur has a halogen content of about 3 wt % to about 8 wt % calculated as bromine relative to the total weight of the sorbent containing halogen and sulfur.

F) A process as in any of A)-E) wherein the amount of sulfur in the sorbent containing halogen and sulfur is in the range of about 0.1 wt % to about 15 wt %, relative to the total weight of the sorbent containing halogen and sulfur.

G) A process as in any of A)-E) wherein the amount of sulfur in the sorbent containing halogen and sulfur is in the range of about in the range of about 0.5 wt % to about 10 wt %, preferably about 1 wt % to about 5 wt %, relative to the total weight of the sorbent containing halogen and sulfur.

H) A process as in any of A)-G) wherein the sulfur and halogen are in an atom ratio of sulfur to halogen in the range of about 0.25:1 to about 1:3, preferably about 0.5:1 to about 1:2.5, and still more preferably about 1:1 to about 1:2.

I) A process as in any of A)-H) wherein the substance is soil.

J) A process as in any of A)-H) wherein the substance is sediment.

K) A process as in any of A)-H) wherein the substance is soil pore water or sediment pore water.

L) A process as in A) wherein the sorbent containing halogen and sulfur is activated carbon containing bromine and sulfur, wherein the halogen content is about 0.1 wt % to about 20 wt %, calculated as bromine relative to the total weight of the sorbent containing halogen and sulfur, and wherein the substance is soil, sediment, soil pore water, or sediment pore water.

M) A process as in L) wherein the halogen content is about 0.5 wt % to about 15 wt %, preferably about 2 wt % to about 12 wt %, more preferably about 3 wt % to about 8 wt %, calculated as bromine relative to the total weight of the sorbent containing halogen and sulfur.

N) A process as in L) or M) wherein the amount of sulfur in the sorbent containing halogen and sulfur is in the range of about 0.1 wt % to about 15 wt %, preferably in the range of about 0.5 wt % to about 10 wt %, more preferably about 1 wt % to about 5 wt %, relative to the total weight of the sorbent containing halogen and sulfur.

O) A process as in A) wherein the sorbent is a chabazite containing bromine and sulfur, a bentonite containing bromine and sulfur, a kaolinite containing bromine and sulfur, or a silica containing bromine and sulfur, wherein the halogen content is about 0.1 wt % to about 20 wt %, calculated as bromine relative to the total weight of the sorbent containing halogen and sulfur, and wherein the substance is soil, sediment, soil pore water, or sediment pore water.

P) A process as in O) wherein the halogen content is about 0.5 wt % to about 15 wt %, preferably about 2 wt % to about 12 wt %, more preferably about 3 wt % to about 8 wt %, calculated as bromine relative to the total weight of the sorbent containing halogen and sulfur.

Q) A process as in 0) or P) wherein the amount of sulfur in the sorbent containing halogen and sulfur is in the range of about 0.1 wt % to about 15 wt %, preferably in the range of about 0.5 wt % to about 10 wt %, more preferably about 1 wt % to about 5 wt %, relative to the total weight of the sorbent containing halogen and sulfur.

R) A process as in A) wherein the sorbent is an activated carbon containing chlorine and sulfur, wherein the halogen content is about 0.1 wt % to about 20 wt %, calculated as bromine relative to the total weight of the sorbent containing halogen and sulfur, and wherein the substance is soil, sediment, soil pore water, or sediment pore water.

S) A process as in A) wherein the sorbent is an activated carbon containing iodine and sulfur, wherein the halogen content is about 0.1 wt % to about 20 wt %, calculated as bromine relative to the total weight of the sorbent containing halogen and sulfur, and wherein the substance is soil, sediment, soil pore water, or sediment pore water.

T) A process as in K) wherein the halogen content is about 0.5 wt % to about 15 wt %, preferably about 2 wt % to about 12 wt %, calculated as bromine relative to the total weight of the sorbent containing halogen and sulfur.

U) A process as in T) wherein the amount of sulfur in the sorbent containing halogen and sulfur is in the range of about 0.1 wt % to about 15 wt %, preferably in the range of about 0.5 wt % to about 10 wt %, more preferably about 1 wt % to about 5 wt %, relative to the total weight of the sorbent containing halogen and sulfur.

V) A process as in any of L)-U) wherein the sulfur and halogen are in an atom ratio of sulfur to halogen in the range of about 0.25:1 to about 1:3, preferably about 0.5:1 to about 1:2.5, and still more preferably about 1:1 to about 1:2.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A process for reducing environmental availability of at least a portion of one or more environmental pollutants in a substance comprising one or more environmental pollutants, which process comprises
adding and/or applying a sorbent containing halogen and sulfur to said substance, wherein the sorbent comprises sulfur, one or more halogens selected from fluorine, chlorine, bromine, and/or iodine, and one or more substrate materials, wherein the halogen in the sorbent is from a source selected from elemental halogens, hydrohalic acids, alkali metal halides, alkaline earth metal halides, and ammonium halides,
thereby reducing environmental availability of at least a portion of one or more environmental pollutants in the substance.

2. A process according to claim 1 wherein the sorbent comprises a substrate material selected from one or more carbonaceous materials, or wherein sorbent comprises a substrate material selected from one or more inorganic materials.

3. A process according to claim 2 wherein the carbonaceous material is activated carbon.

4. (canceled)

5. A process according to claim 2 wherein the inorganic material is selected from inorganic oxides, natural zeolites, CaCO₃, and clay minerals.

6. A process according to claim 5 wherein the inorganic material is selected from chabazite, silica, kaolinite, and bentonite.

7. A process according to claim 1 wherein the sorbent containing halogen and sulfur is a sorbent containing bromine and sulfur.

8. (canceled)

9. A process according to claim 1 wherein the sorbent is an activated carbon containing bromine and sulfur.

10. A process according to claim 1 wherein the sorbent has a halogen content of about 0.1 to about 20 wt % calculated as bromine relative to the total weight of the sorbent containing halogen and sulfur.

11. A process according to claim 1 wherein the amount of sulfur in the sorbent containing halogen and sulfur is in the range of about 0.1 wt % to about 15 wt % relative to the total weight of the sorbent containing halogen and sulfur.

12. A process according to claim 1 wherein the substance comprising said environmental pollutants is a solid, wherein adding and/or applying the sorbent containing halogen and sulfur to the solid comprises:
(a) injecting a sorbent containing halogen and sulfur into the solid;
(b) applying a sorbent containing halogen and sulfur to a surface of the solid;
(e) combining a sorbent containing halogen and sulfur with at least a portion of a surface of the solid;
(d) placing a sorbent containing halogen and sulfur in a vacuum well in which the solid is treated;
(e) adding a sorbent containing halogen and sulfur to a contained solid;
(f) combining a sorbent containing halogen and sulfur with the solid;
(g) adding a sorbent containing halogen and sulfur to a reactive barrier; and/or
(h) forming a reactive barrier containing a sorbent containing halogen and sulfur.

13. (canceled)

14. A process according to claim 1 wherein the substance comprising said environmental pollutants is a liquid, wherein adding and/or applying the sorbent containing halogen and sulfur to the liquid comprises:
(a) injecting a sorbent containing halogen and sulfur into the liquid;
(b) applying a sorbent containing halogen and sulfur to the surface of the liquid;
(c) combining a sorbent containing halogen and sulfur with the liquid;
(d) passing the liquid over a fixed bed comprising a sorbent containing halogen and sulfur;
(e) passing the liquid through a filter comprising a sorbent containing halogen and sulfur;
(f) pumping the liquid through a fixed bed or column containing a sorbent containing halogen and sulfur; and/or
(g) adding a sorbent containing halogen and sulfur to a contained volume of liquid.

15. (canceled)

16. A process according to claim 1 wherein the substance comprising said environmental pollutants is a combination of at least one solid and at least one liquid, wherein adding and/or applying the sorbent containing halogen and sulfur to the combination comprises:
(a) injecting a sorbent containing halogen and sulfur into the combination;
(b) applying a sorbent containing halogen and sulfur to a surface of the combination;
(c) combining a sorbent containing halogen and sulfur with at least a portion of a surface of the combination;
(d) combining a sorbent containing halogen and sulfur with the combination;
(e) placing a sorbent containing halogen and sulfur in a vacuum well in which the combination is treated;
(f) adding a sorbent containing halogen and sulfur to a contained combination;
(g) covering a surface of the substance with a layer comprising a sorbent containing halogen and sulfur;
(h) placing a sorbent containing halogen and sulfur into a cap;
(i) adding a sorbent containing halogen and sulfur to a reactive barrier;
(j) forming a reactive barrier containing a sorbent containing halogen and sulfur; and/or
(k) placing a sorbent containing halogen and sulfur within a geotextile mat.

17. (canceled)

18. A process according to claim 12 wherein the solid is soil, wherein the adding and/or applying comprises:
(a) injecting a sorbent containing halogen and sulfur into the solid;
(b) applying a sorbent containing halogen and sulfur to a surface of the solid; and/or
(c) combining a sorbent containing halogen and sulfur with at least a portion of a surface of the solid.

19. (canceled)

20. A process according to claim 16, wherein the combination is sediment wherein the adding and/or applying comprises:
(a) injecting a sorbent containing halogen and sulfur into the combination;
(b) applying a sorbent containing halogen and sulfur to a surface of the combination;
(e) combining a sorbent containing halogen and sulfur with at least a portion of a surface of the combination; and/or
(d) combining a sorbent containing halogen and sulfur with the combination.

21. (canceled)

22. A process according to claim 1 wherein the substance is soil or sediment, and wherein the sorbent containing halogen and sulfur is an activated carbon containing bromine and sulfur.

23. A sorbent containing halogen and sulfur, wherein the sorbent is formed by:
A) i) contacting a halogen-containing compound and a substrate material to form a halogen-containing substrate material, and ii) contacting the halogen-containing substrate material with a sulfur source; or
B) contacting a halogen-containing substrate material and a sulfur source; or
C) i) contacting a halogen-containing compound and a sulfur source to form a halogen-sulfur mixture, and ii) contacting the halogen-sulfur mixture and a substrate material;
to form a sorbent containing halogen and sulfur.

24. A sorbent as in claim 23 wherein the halogen is bromine, the substrate material is a carbonaceous material, the halogen-containing compound is elemental bromine, and the sulfur source is elemental sulfur.

25. A sorbent as in claim 24 wherein the sorbent is formed as in A), and the elemental bromine is in gaseous form; or wherein the sorbent is formed as in C), and the elemental bromine is in liquid form.

26. A sorbent as in claim 23 wherein the substrate material is activated carbon.

27. A process for forming a sorbent containing halogen and sulfur, which process comprises:
A) i) contacting a halogen-containing compound and a substrate material to form a halogen-containing substrate material, and
ii) contacting the halogen-containing substrate material with a sulfur source; or
B) contacting a halogen-containing substrate material and a sulfur source; or
C) i) contacting a halogen-containing compound and a sulfur source to form a halogen-sulfur mixture, and
ii) contacting the halogen-sulfur mixture and a substrate material;
to obtain a sorbent containing halogen and sulfur.

28. A process as in claim 27 wherein the halogen is bromine, the substrate material is a carbonaceous material, the halogen-containing compound is elemental bromine, and the sulfur source is elemental sulfur.

29. A process as in claim 28 wherein the sorbent is formed as in A), and the elemental bromine is in gaseous form; or wherein the sorbent is formed as in C), and the elemental bromine is in liquid form.

30. A process as in claim 27 wherein the contacting of the sulfur source and substrate material in A) or B), or the contacting the halogen-sulfur mixture and a substrate material in C) is conducted at one or more temperatures in the range of about 75° C. to about 700° C.

31. A process as in claim 27 wherein the substrate material is activated carbon.
